(19) United States
(12) Patent Application Publication
(10) Pub. No.: US 2014/0054977 A1
(43) Pub. Date: Feb. 27, 2014

(54) STRUCTURE FOR AN INTELLIGENT WIRELESS COMMUNICATION SOCKET

(71) Applicants: Roy Ting, New Taipei City (TW); Max Li, Dana Point, CA (US)

(72) Inventors: Roy Ting, New Taipei City (TW); Max Li, Dana Point, CA (US)

(21) Appl. No.: 13/592,339

(22) Filed: Aug. 23, 2012

(51) Int. Cl. H01H 83/06

(52) U.S. Cl. 307/140

(57) ABSTRACT

An improved structure for an intelligent wireless transmission communication socket includes a wireless intelligent socket and at least one extension antenna. Socket aperture sets are disposed on the top of the intelligent wireless socket, and a control circuit is set inside the intelligent wireless socket to detect electricity consumption of each socket aperture set and wirelessly send the detected electricity consumption information. A contact jack is placed on a side face of the intelligent wireless socket, and electrically connected to the control circuit. One end of the extension antenna is connected to the contact jack, and another end extends out from behind an obstacle in front of the intelligent wireless socket. Information detected by the control circuit is sent out through the extension antenna, improving transmission of the detected information.

### BACKGROUND OF THE INVENTION

1. Field of the Invention

The present invention relates to an improved structure for an intelligent wireless transmission communication socket, and more particularly to an intelligent wireless socket with an extended antenna inserted in one side thereof, thereby increasing the transceiving effect of the information detected thereby.

2. Background

Because energy shortages are becoming worse and worse, there is a general consensus for saving energy saving and protecting the environment. Research shows that up to ten percent of domestic electricity is wasted in standby states when an appliance is plugged in but not turned off.

Fortunately, a newly developed intelligent chip module may be assembled in a domestic appliance, thereby reducing electrical consumption when the appliance is plugged in and in a standby state, or which can be designed into an intelligent socket, used for detecting abnormal electrical consumption patterns, allowing domestic electrical power to be managed digitally so as to avoid a great deal of unnecessary waste and to achieve energy savings. Furthermore, power can be cut off automatically when electricity is consumed abnormally in an appliance, allowing the power usage in a whole house to be more flexible and safe.

Currently, a conventional intelligent wireless network socket is configured with a control circuit with an intelligent chip module therein so as to be used to detect the power consumption of the conventional intelligent sockets through the control circuit, and send the detected power consumption information to a control end (e.g. host server) by means of a wireless transmission (e.g. Internet transmission), and the control end carries out the function of integrated control based on the collected power consumption information, thereby providing the safety protection of cutting off power automatically when electric equipment is overloaded or when in standby.

However, a signal tranceiver of the control circuit of the conventional intelligent wireless network socket is positioned inside the intelligent wireless network socket, and sockets on walls are generally positioned behind electrical equipment, cupboards, or steel cabinets. As a result, detection signals sent by the control circuit of the conventional intelligent wireless network socket are always blocked or interfered with by the electrical equipment itself or by obstacles in front of the intelligent wireless network socket, causing the detection signals sent from the control circuit not to be transmitted to the control end effectively, and thus the control end not to completely receive and collect the detection signals sent from each intelligent wireless network socket. Therefore, a serious loophole can occur with regards to intelligent power control, causing the conventional intelligent wireless network socket to forfeit its efficacy and fail its purpose. It is therefore conceivable that in a household electricity cannot really be adequately controlled, and the accumulation over multiple households can be significant. Consequently, the control of electricity in an entire city or even a whole country is affected.

### SUMMARY OF THE INVENTION

To improve the defects of the conventional structures mentioned above, the present invention is proposed.

The present invention proposes an improved structure for an intelligent wireless transmission communication socket, including an intelligent wireless socket and at least one extension antenna. At least two socket aperture sets are disposed on a top of the intelligent wireless socket, and a control circuit is configured inside the intelligent wireless socket; the control circuit is used for detecting the power consumption of each socket aperature set, and sending out the detected information wirelessly, where one side face of the intelligent wireless socket is disposed with at least one contact jack connected electrically to the control circuit configured inside the intelligent wireless socket. One end of the extension antenna is inserted in and in electrical communication with the contact jack, and another end thereof extends out from an obstacle in front of the intelligent wireless socket to the outside. Information detected by the control circuit can be sent out through the extension antenna extended in an outward direction from the socket, achieving an increase in the transceiving effect of the information detected by the intelligent wireless socket.

### BRIEF DESCRIPTION OF THE DRAWINGS

The present invention can be more fully understood by reference to the following description and accompanying drawings, in which:

FIG. 1 is a schematic view of a conventional intelligent wireless socket structure while being put into practice;

FIG. 2 is an exploded view of a first preferred embodiment according to the present invention;

FIG. 3 is a perspective view of the first embodiment according to the present invention;

FIG. 4 is schematic view of the first embodiment according to the present invention while being put into practice;

FIG. 5 is an exploded view of a second preferred embodiment according to the present invention;

FIG. 6 is a perspective view of the second embodiment according to the present invention;

FIG. 7 is a schematic view of the second embodiment according to the present invention while being put into practice;

FIG. 8a is a schematic view of an extension antenna further added with a positioning element on a tip thereof;

FIG. 8b is another schematic view of an extension antenna further added with a positioning element on a tip thereof;

FIG. 9 is top and side views of the first embodiment of the present invention configured additionally with a wire winding portion; and

FIG. 10 is top and side views of the second embodiment of the present invention configured additionally with a wire winding portion.

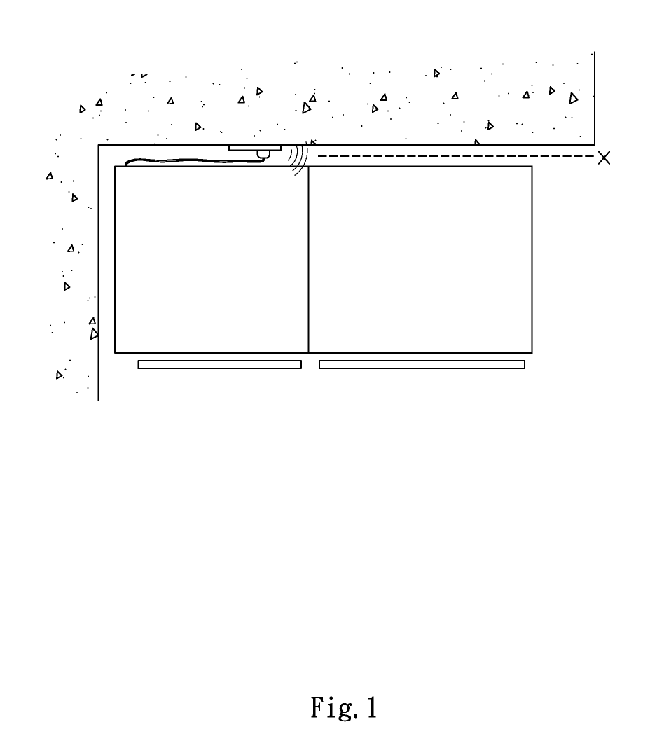

### DETAILED DESCRIPTION OF THE PREFERRED EMBODIMENTS

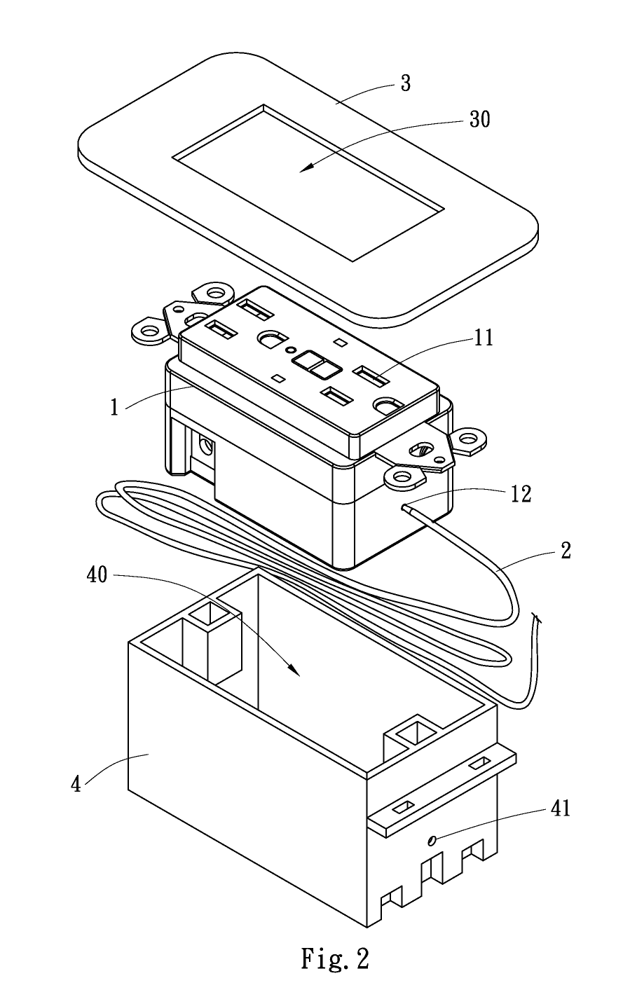

Referring to FIGS. 2 to 4, an improved structure for an intelligent wireless transmission communication socket according to a first preferred embodiment of the present invention, which primarily includes an intelligent wireless socket 1 and at least one extension antenna 2, where the intelligent wireless socket 1 is configured with at least two socket aperture sets 11 on the top surface thereof, and a control circuit (not shown in the figures) is configured inside the intelligent wireless socket 1. The control circuit is used for detecting the electricity consumption of each socket aperture set 11 (e.g. including voltage and current power consumption), and sending out the detected electricity consumption information by means of wireless transmission (Internet (IP) transmission, e.g. WIFI or Bluetooth transmission). Furthermore, at least one contact jack 12 is disposed on one side face of the intelligent wireless socket 1, which is electrically connected to the control circuit disposed inside the intelligent wireless socket 1.

One end of the extension antenna 2 is inserted in and in electrical communication with the contact jack 12, and another end thereof is provided for extending out from an obstacle in front of the intelligent wireless socket 1.

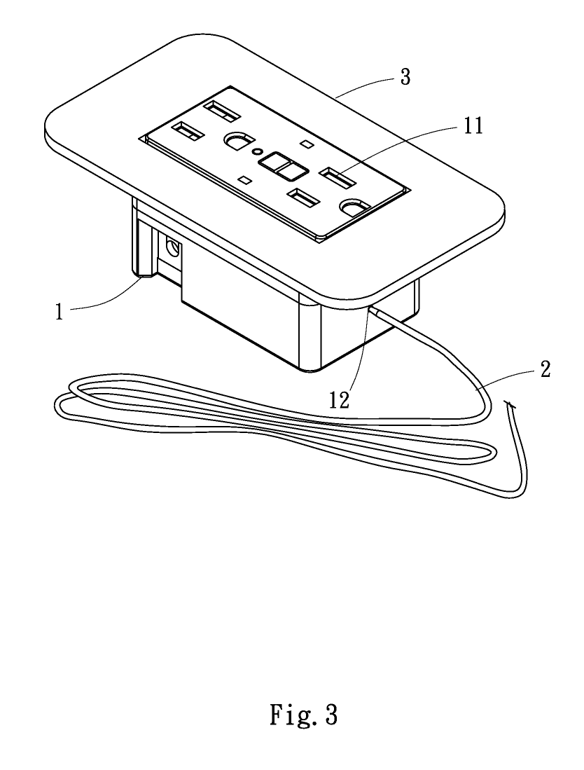

Furthermore, the embodiment of the present invention includes a cover plate 3 and a socket case 4. The cover plate 3 is disposed with an opening 30, which is positioned correspondingly to the socket aperture sets 11 configured on the intelligent wireless socket 1. The cover plate 3 may be coupled to the top surface of the intelligent wireless socket 1, allowing the socket aperture sets 11 to be exposed out therefrom. The socket case 4 has an accepting space 40, and a through hole 41 corresponding to the contact jack 12 of the intelligent wireless socket 1 is configured on one side face of the socket case 4. Furthermore, the intelligent wireless socket 1 may be placed in the accepting space 40 of the socket case 4, and the extension antenna 2 may be passed through the through hole 41 and extend out of the socket case 4 to the outside, as FIG. 3 shows.

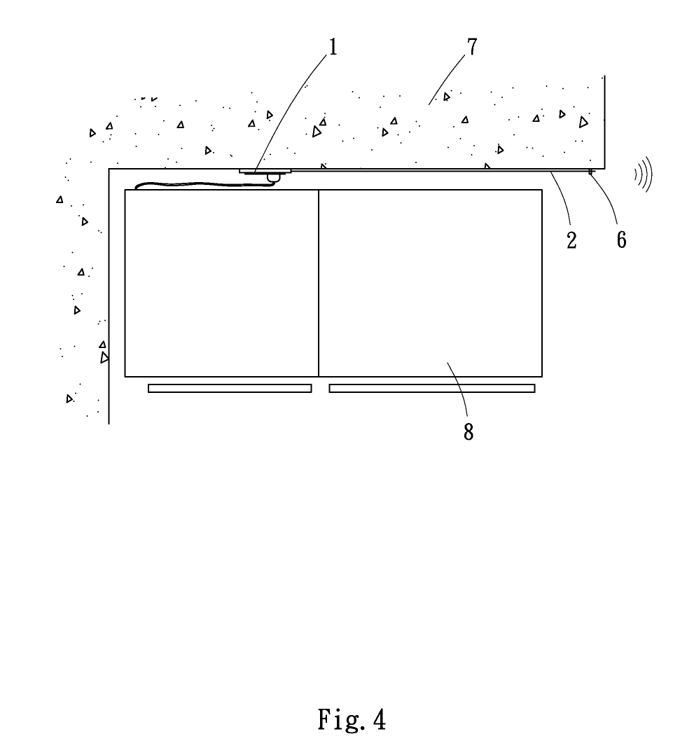

When an embodiment of the present invention is put into practice, as FIGS. 3 and 4 show, the intelligent wireless socket 1 may be installed on a wall face 7, and the socket aperture sets 11 configured on the intelligent wireless socket 1 are relatively exposed out of the wall face 7. Furthermore, the extension antenna 2 may be extended outward along the wall face 7 or an object, allowing the extension antenna 2 to extend out in front of an obstacle that is in front of the intelligent wireless socket 1 and thus to the outside of the object thereof, such as the outside of an appliance 8. As a result, the control circuit is used to detect the electricity consumption (e.g. including voltage and current consumption) of each socket aperture set 11 when the intelligent wireless socket 1 is in use, and send the detected electricity consumption information to the outside through the extension antenna 2, thereby preventing the electricity consumption information emitted from the intelligent wireless socket 1 from being blocked, interfered with or shielded by a variety of obstacles or the appliance 8, and further increasing the transceiving effect of the (electricity consumption) information detected by the intelligent wireless socket 1.

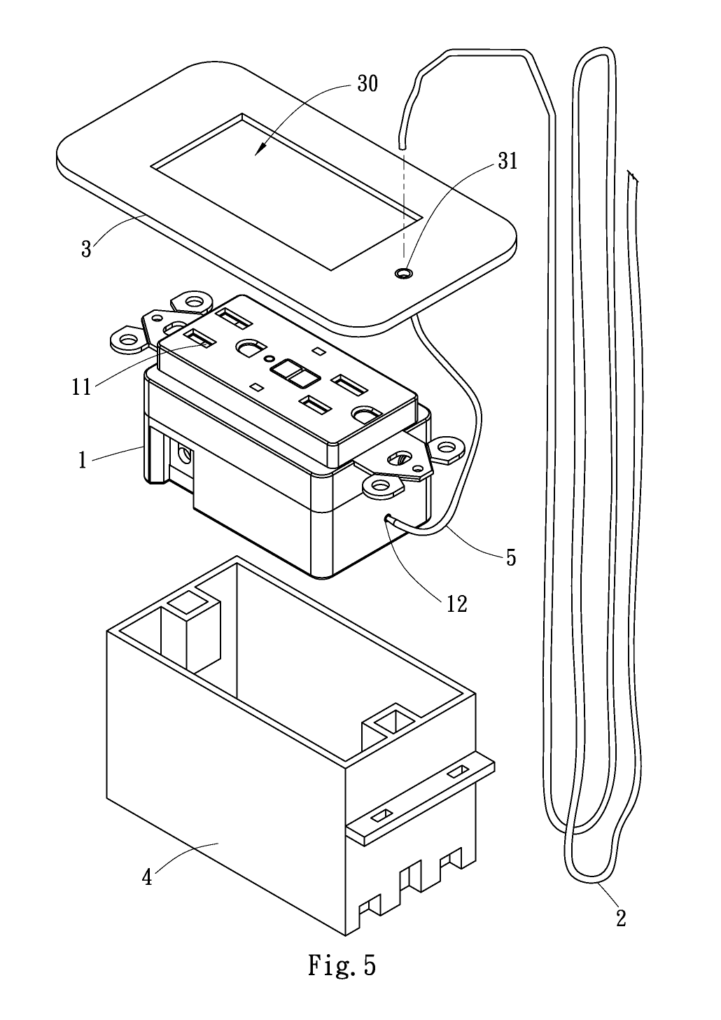

Referring to FIGS. 5 to 7, the figures show a second preferred embodiment according to the present invention. At least one contact jack 12 is similarly disposed on one side face of the intelligent wireless socket 1, and electrically connected to the control circuit disposed inside the intelligent wireless socket 1. An opening 30 corresponding to the positions of the socket aperture sets 11 disposed on the intelligent wireless socket 1 is configured on the cover plate 3, which may be coupled to the top surface of the intelligent wireless socket 1. Furthermore, at least one connection jack 31 is disposed on the cover plate 3, where the connection jack 31 is a through hole penetrating from the outside to the inside of the cover plate 3, and a socket case 4 is configured behind the cover plate 3, allowing the intelligent wireless socket 1 to be placed therein. One end of a connection wire 5 is inserted in and electrically connected to the contact jack 12 of the intelligent wireless socket 1, and another end thereof is electrically connected to the inner side end of the connection jack 31 of the cover plate 3. Furthermore, the outer side end of the connection jack 31 is then provided for electric connection with the extension antenna 2, thereby lengthening and extending the extension antenna 2 to extend beyond an obstacle in front of the wireless intelligent socket 1.

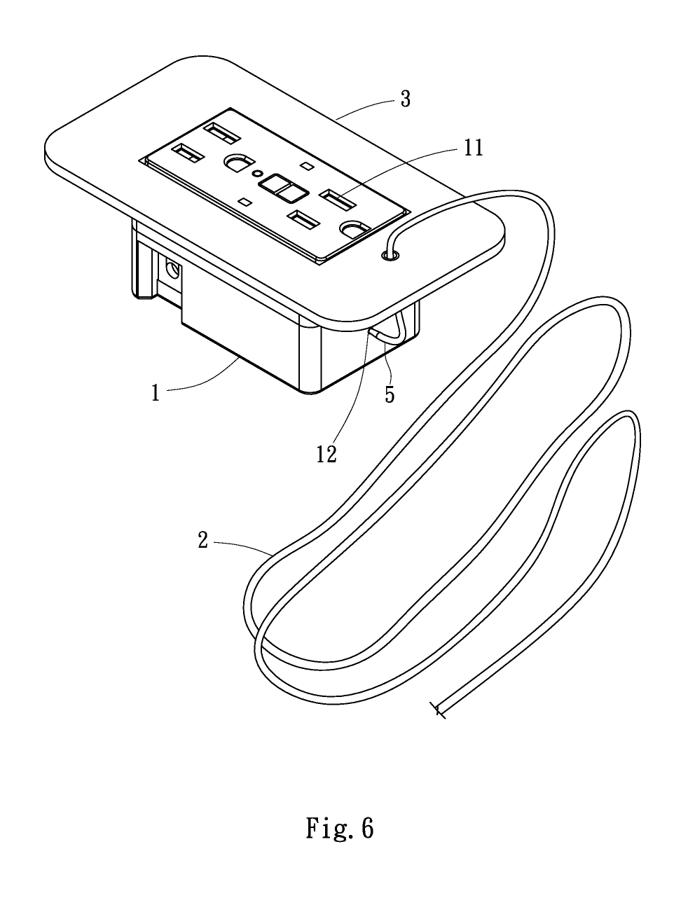

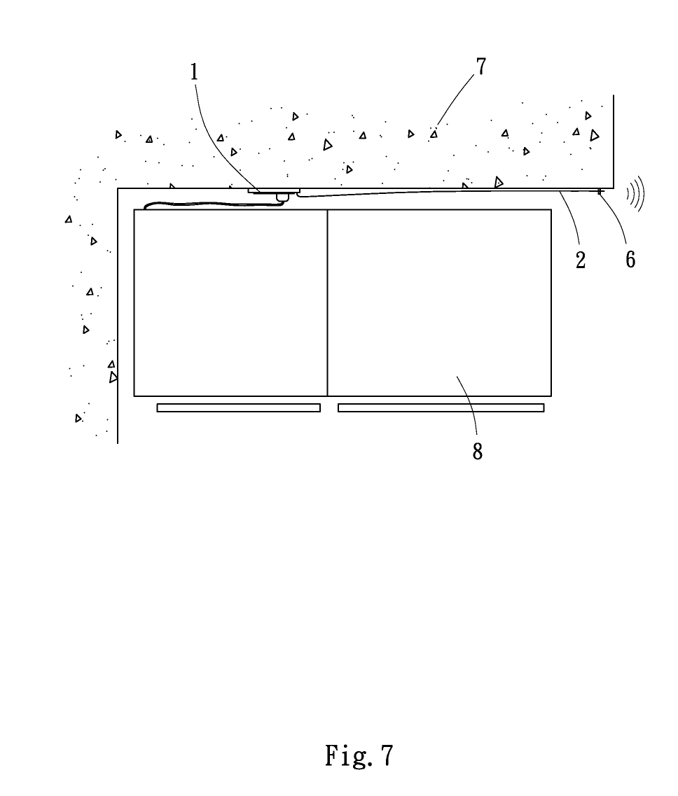

When the present invention is put into practice, as FIGS. 6 and 7 show, the intelligent wireless socket 1 may also be installed on the wall face 7, and the socket aperture sets 11 are configured on the intelligent wireless socket 1 to be exposed out of the wall face 7. The connection wire 5 may be positioned inside the cover plate 3 (therefore, it is not shown in FIG. 4). One end of the extension antenna 2 may be electrically connected to the connection jack 31 on the outside of the cover plate 3, allowing the extension antenna 2 to be in electrical communication with the connection wire 5, and another end (free end) of the extension antenna 2 is then extended outward along the wall face 7 (or an object), allowing the extension antenna 2 to extend out beyond the appliance 8 in front of the intelligent wireless socket 1 to the outside thereof. As a result, the control circuit is used to detect the electricity consumption of an appliance (e.g. including voltage and current consumptions) for each socket aperture set 11 when plugged into the intelligent wireless socket 1, and send the detected electricity consumption to the outside through the connection wire 5 and the extension antenna in sequence, thereby preventing the electricity consumption information emitted from the intelligent wireless socket 1 from being blocked, interfered with or shielded by a variety of obstacles or the appliance 8, and further increasing the transceiving effect of the electricity consumption information detected by the intelligent wireless socket 1.

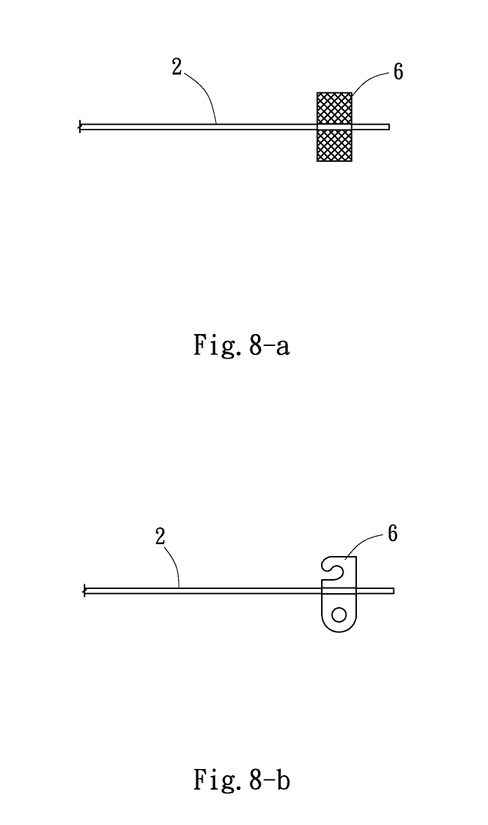

Referring to FIGS. 8a and 8b, a tip of the extension antenna 2 of the first and second embodiments (also see FIGS. 4 and 7) may be further coupled to a positioning element 6, for example, adhesive tape, lockhole sheet or hook, etc., thereby securing the tip of the extension antenna 2 on the wall face 7 or the surface of another object, and assuring that the extension antenna 2 may extend outward and be well secured.

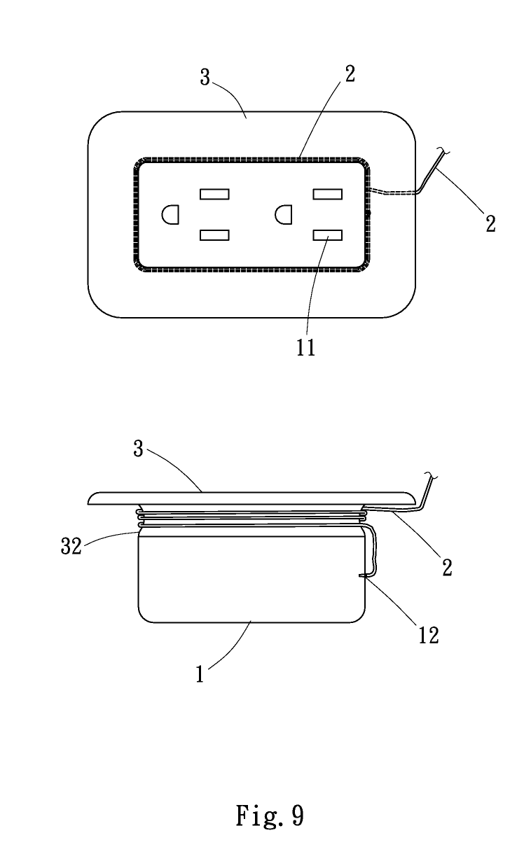

Furthermore, referring to FIGS. 3 and 9, to match different house environments, landforms and surface features, the periphery of the opening 30 of the cover plate of the first embodiment may be extended downward and added with a wire winding portion 32, allowing the extension antenna 2 to be wound around the wire winding portion 32 in advance, and then the free end of the extension antenna 2 can be extended outward to the outside, thereby allowing a user themselves to adjust the extension length of the extension antenna 2 according to a required extension distance.

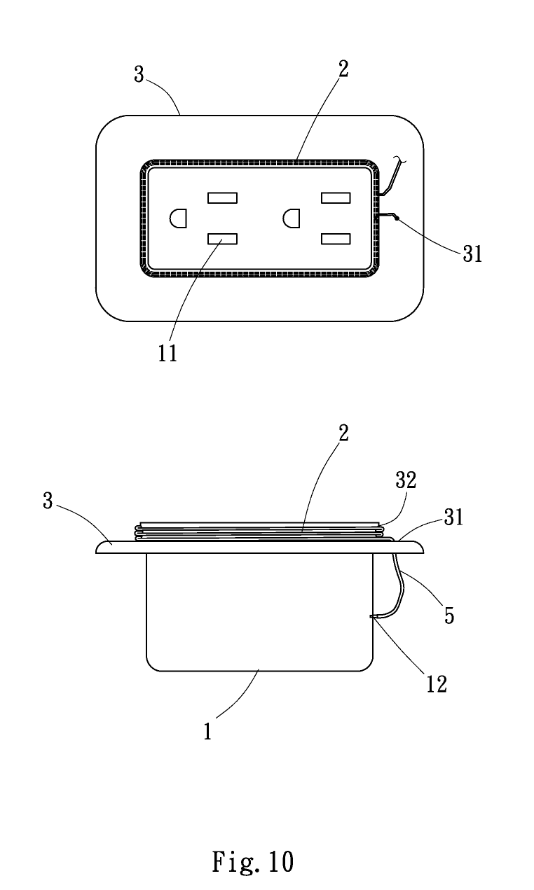

Furthermore, referring to FIGS. 6 and 10, the periphery of the opening 30 of the cover plate 3 of the second embodiment may then be extended upward with a wire winding portion 32, allowing the extension antenna 2 to be wound around the wire winding portion 32 in advance, and then the free end of the extension antenna 2 can be extended outward to the outside, thereby allowing a user themselves to adjust the extension length of the extension antenna 2 according to a required extension distance.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An improved structure of an intelligent wireless transmission communication socket, comprising an intelligent wireless socket and at least one extension antenna, at least two socket aperture sets being configured on a top of said intelligent wireless socket, and a control circuit disposed inside said intelligent wireless socket, said control circuit being used to detect electricity consumption of each of said aperture sets, and send out said detected electricity consumption information wirelessly; wherein at least one contact jack is configured on a side face of said intelligent wireless socket, and said contact jack being electrically connected to said control circuit disposed inside said intelligent wireless socket; and wherein an end of said extension antenna is inserted in and in electrical communication with said contact jack, and another end thereof is configured to extend out from an obstacle in front of said intelligent wireless socket.

2. The improved structure of an intelligent wireless transmission communication socket according to claim 1, further comprising a cover plate and a socket case, said cover plate having an opening at a position corresponding to said socket aperture sets configured on said wireless intelligent socket, and said cover plate is coupled to a top surface of said wireless intelligent socket; wherein said socket case has an accepting space, and a side face of said socket case includes a through hole corresponding to said contact jack, said wireless intelligent socket being placed in said accepting space of said socket case, and said extension antenna passing through said through hole to extend out of said socket case.

3. The improved structure of an intelligent wireless transmission communication socket according to claim 2, wherein a periphery of said opening of said cover plate extends downward to form a wire winding portion.

4. The improved structure of an intelligent wireless transmission communication socket according to claim 1, wherein said extension antenna is coupled to at least one positioning element to mount on an object surface.

5. An improved structure for an intelligent wireless transmission communication socket, comprising:
an intelligent wireless socket, at least two socket aperture sets being configured on a top thereof, a control circuit being configured inside said intelligent wireless socket, said control circuit being used to detect electricity consumption of each of said socket aperture sets and sending out said detected electricity consumption information wirelessly, a side face of said intelligent wireless socket including at least one contact jack electrically connected to said control circuit;
a cover plate having an opening at a position corresponding to said socket aperture sets, said cover plate being coupled to a top surface of said intelligent wireless socket, and said cover plate including at least one connection jack, said connection jack penetrating through said cover plate from an inner side face to outer side face thereof;
at least one connection wire, one end thereof being inserted in and in electric communication with an outer side end of said contact jack, and another end thereof being electrically connected to an inner side end of said connection jack of said cover plate; and
at least one extension antenna, an end thereof being electrically connected to an outer side end of said connection jack, and another end thereof configured to extend outside of an obstacle in front of said wireless intelligent socket.

6. The improved structure for an intelligent wireless transmission communication socket according to claim 5, wherein a periphery of said opening of said cover plate extends upward to form a wire winding portion.

7. The improved structure for an intelligent wireless transmission communication socket according to claim 5, wherein said extension antenna is coupled to at least one positioning element to for securing on an object surface.

8. The improved structure for an intelligent wireless transmission communication socket according to claim 5, wherein a socket case is further disposed behind said cover plate, allowing said wireless intelligent socket to be placed therein.
